(19) United States
(12) Patent Application Publication
(10) Pub. No.: US 2004/0113455 A1
(43) Pub. Date: Jun. 17, 2004

(54) Energy absorbing impact deflector incorporating a thermoformed outer panel and an expanded foam insert

(76) Inventor: Glen D. Schmidt, New Baltimore, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/729,042

(22) Filed: Dec. 5, 2003

Related U.S. Application Data
(63) Continuation-in-part of application No. 10/272,750, filed on Oct. 17, 2002.

(51) Int. Cl. B60J 5/00

(52) U.S. Cl. 296/146.6

(57) ABSTRACT

A combination energy absorption and environmental insulating barrier incorporated into a vehicle door trim panel assembly. A thermoformed and hardened shell has an exterior facing surface and an opposite recessed interior facing surface. A three-dimensional structural component is constructed of a durable plasticized and expanded foam material and exhibiting the properties of moisture imperviousness and impact resistance. The structural component has a specified length, width and thickness and is configured to substantially seat against the recessed interior facing surface of the shell. A dimensional misalignment tolerancing being established between the opposing facing surfaces of the thermoformed shell and the expanded structural component and owing to tolerancing vagaries associated with the expanded foam of the structural component. An exposed facing surface of the structural component secures against an inner associated surface of a vehicle door.

### CROSS-REFERENCE TO RELATED APPLICATION

The present application is a continuation-in-part of U.S. application Ser. No. 10/272,750, filed Oct. 17, 2002, and entitled “Energy Absorbing Impact Deflector for Use in Vehicle Doors”.

### BACKGROUND OF THE INVENTION

1. Field of the Invention

The present invention relates generally to both impact resistant barriers for incorporation into a vehicle door, as well as water, dust and sound barrier applications. More particularly, the present invention discloses a two-piece structural panel and trim pad construction for incorporation into a vehicle door. The trim panel in particular includes a thermoformed and relatively thin, hardened outer shell having a high degree of tolerance accuracy, and over which may or may not be applied a decorative covering. A three-dimensional structural component, and such as which may be constructed of an expanded plastic/foam insert, fits within a negative facing side of the outer shell and further such that the outer shell accommodates for misalignments due to poorer dimensional tolerances associated with the expandable structural insert.

2. Description of the Prior Art

The manner in which automobile manufacturers assemble vehicles is in the process of changing. At present, a total of three thousand or more parts comprise an assembled vehicle. It is a directive of automotive manufacturers that as many of these pieces as possible be incorporated into sub-assemblies, such as by an off-site vehicle supplier, prior to shipping and final assembly in an OEM plant.

Numerous attempts have been made in particular to design and manufacture a water deflector that would attach to a trim pad and seal against an inner panel of sheet metal associated with a vehicle door. The impracticality of such designs is in part owing to non-existence of materials stiff or strong enough to support itself so that it might seal to the sheet metal when the trim pad is installed. Materials exhibiting these capabilities are typically more expensive than such as poly-sheets currently in use.

Current material constructions for interior door trim pads further includes such as the use of an injected molded polypropylene inner panel, which exhibits various clips and fasteners formed into the part. This is typically the most cost effective method of producing such parts for high volume production. However, as the auto industry moves toward lower volume, niche vehicle production, the cost of injection forming molds becomes prohibitive. Furthermore, attempts have been made to thermoform these parts, such processes typically being incapable of forming the geometric configurations required for clips and fasteners.

Among the relevant prior art is the vehicle door panel and construction disclosed in U.S. Pat. No. 6,447,047, issued to Marcovecchio et al., and which in particular discloses a structure having an outer wall and an inner wall in which at least one opening is provided. A self-supporting panel is attached to the structure and provides sealing relative to the inner wall. A frame surrounds the panel and the door includes fixing parts having a first part attached to the structure and a second part attached to the panel, the parts cooperating with one another in order to fix the panel directly to the structure so that the frame is supported by the panel.

Among the drawbacks associated with Marcovecchio include the difficulties encountered in achieving acceptable dimensional tolerances during the formation of the expanded polypropylene or other plastic-based and expanded foam. It is well known in the art that such plasticized foam materials exhibit inherent tolerances of plus or minus 1%, this rendering it very impractical to form parts to acceptable tolerances within the tight-fitting confines of a vehicle door interior.

U.S. Pat. No. 6,474,721, issued to Nishikawa, teaches a vehicle door assembly having an outer door panel, an inner door panel formed with an aperture, and a plastic panel to which functional devices associated with the vehicle door and door parts are installed and which is installed to the inner door panel to close up the aperture of the inner door panel. An impact absorbing member is formed as a part integral with the plastic panel or is fixedly secured to the plastic panel and which absorbs an impact against the plastic panel upon an occurrence of a side crash of the vehicle.

U.S. Pat. No. 3,989,275, issued to Finch, teaches an energy absorbing component for use in a vehicle door and which is molded of a rigid plastic foam covered with a layer of semi-rigid and like plastics foam. The rear face of the molding is formed with a plurality of integral projections which are arranged to collapse, and thereby absorb energy, upon occupant impact. The projections may further comprise rib-like walls defining a series of discrete cavities, and may include columns extending to the rear face of the molding.

Finally, U.S. Pat. No. 5,456,513, issued to Schmidt, discloses a sound, water and dust barrier having a laminated body with a central layer composed of a filled plastic which provides sound dampening characteristics to the water barrier. Additional outer layers of an unfilled plastic sandwich about the central layer. Vacuum formed speaker recesses or like contoured shapes may be provided for accommodating suitable components and flexible clip pockets are sealingly attached about openings in the body to allow the water barrier to be clipped to the inner and outer door panels of the vehicle door. An adhesive and release agent may be applied on the opposing outer layers and, in the preferred application, the center and outer layers are coextruded together.

### SUMMARY OF THE PRESENT INVENTION

The present invention discloses a two-piece structural panel and trim pad construction for incorporation into a vehicle door and which provides the combined aspects of environmental (water, dust and sound) protection as well as side impact deflection. The trim panel in particular includes a thermoformed and relatively thin, hardened outer shell having a high degree of tolerance accuracy, and over which may or may not be applied a decorative covering, including such as vinyl, leather or other decorative coating layers.

A three-dimensional structural component, and such as which may be constructed of an expanded and energy absorbing plastic/foam insert, fits within a negative facing side of the outer shell and further such that the outer shell accommodates for misalignments due to poorer dimensional tolerances associated with the expandable structural insert. The opposingly facing sides established between the foam insert and the thermoformed shell further include such as interengaging Velcro® portions, spring clips or other types of adjustable fasteners, and which facilitate inevitable misalignments due to the tolerancing variances of the expanded foam insert.

The expandable foam insert component further includes the necessary clips and fasteners for attachment to the inner cavity of the vehicle door and for carrying parts normally installed into the door trim pad. The structural insert additionally serves as a water deflector and structurally supports parts and components normally associated with the vehicle door.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded perspective view of a thermoformed trim panel shell and expanded foam structural component for installation into an inner facing vehicle door cavity according to the present invention;

FIG. 2 illustrates a side cutaway view of the components shown in FIG. 1 and which opposite facing surfaces of the expanded foam structural insert and thermoformed shell exhibit inter-attachable portions;

FIG. 3 is a further enlarged side cutaway sectional illustration by which a molded-in clip is provided along an inner facing surface of the foam insert and which engages a suitably formed aperture located in the inner facing surface of the vehicle door; and

FIG. 4 is a sectional cutaway of an alternate arrangement for securing the shell/expanded insert to an exposed facing surface of a vehicle in an offset tolerance fashion and which in particular includes the provision of screw fasteners located about a lip periphery of the attachable component.

### DETAILED DESCRIPTION OF THE PREFERRED EMBODIMENTS

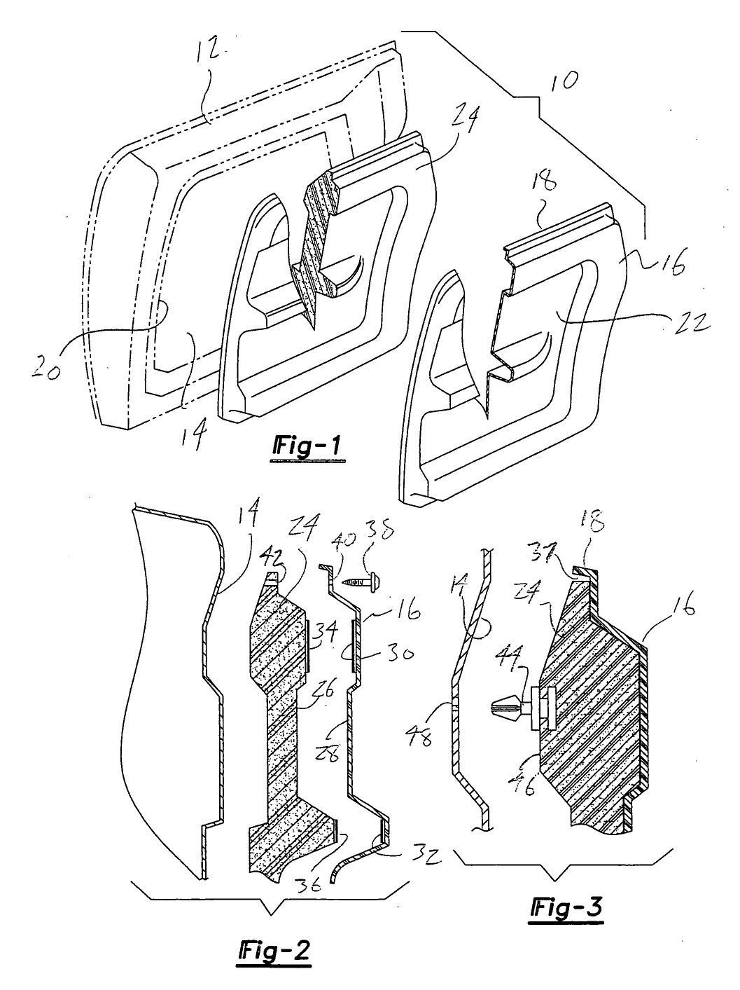

Referring now to FIG. 1, a two-piece structural panel and trim pad construction is generally illustrated at 10 for incorporation into a vehicle door 12 assembly according to the present invention. The vehicle door 12 further includes an interior facing and recessed inner surface 14, typically exhibiting a specified three-dimensional configuration as best illustrated in the side cutaway of FIG. 2.

An outer shell 16 is constructed of a relatively thin and typically thermoformed material, such as further including an acetyl butyl styrene or other suitable plastic based material and which lends itself to forming to a high degree of dimensional accuracy. An outline 18 of the outer shell 16 matches that indicated at 20 (FIG. 1) of the vehicle door 12 and provides consistent geometric tolerancing as required by standard industry designs for interior trim. It is further contemplated that a decorative covering may be applied against an exterior facing surface 22 of the shell 16, the covering including such as a leather or vinyl cladding applied in a conventional manufacturing step.

A three-dimensional structural component is illustrated at 24 and is typically produced from a durable and expanded plasticized foam material. Other suitable materials selected for the structural component may also include an energy absorbing foam mixed with a urethane/impact resistant styrene. As is illustrated, the structural component 24 exhibits a three-dimensional surface configuration on both first and second facing surfaces, and with or without apertures formed therethrough, and the material selection of the component 24 provides such features as moisture imperviousness, acoustical insulation and impact absorbing characteristics.

It has also been determined that the use of expanded polymer enables the amount of energy that is dissipated, upon the occurrence of a side impact along the door, to be directly proportional to the amount of material in the impact area and the density of the material used. In a preferred variant, the expanded polymer making up the structural component 24 can be molded at a density ranging from two pounds per square foot up to twenty pounds per square foot or higher.

Use of the expanded polymer in making a water deflector that typically covers the entire vehicle door, and designing it to fit into many of the available voids existing in conventional door frames, greatly increases the safety of the vehicle and provides a superior product at a reduced cost and typically a reduced weight. The present invention also improves safety and comfort by increasing the amount of energy dissipating material in the crucial areas while providing a capable water and sound barrier.

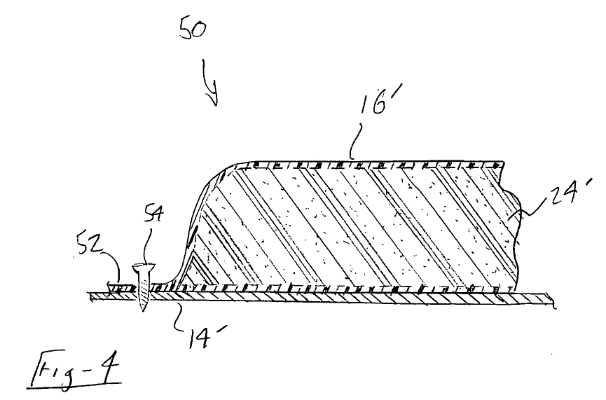

As is known in the relevant art, expanded foam components typically exhibit a dimensional tolerancing of at least plus or minus one percent in size, and it is contemplated that a suitable dimensional misalignment tolerancing is established between a selected outer facing and three-dimensional surface 26 of the structural component 24 and an opposing and inner facing surface 28 of the outer shell 16 (see again FIG. 2). Interengaging portions are established between the opposing surfaces of the outer shell and structural component, see again at 26 and 28, and in a preferred variant are provided by such as Velcro® portions 30 and 32 applied along inner facing locations of the shell 16 which matingly engage against additional such portions 34 and 36 along the opposing surface of the expanded structural component 24. As best shown in FIG. 3, a spacing offset 37 is illustrated between the outer edge of the structural component 24 and the outer periphery 18 of the shell 16 and to accommodate the required tolerances associated with the expanded structural component 24.

Additionally, other interengaging structure may also be substituted for that shown and which may include spring clips and the like. As also shown in FIG. 2, conventional screw fasteners, see at 38, are utilized and which insert through aligning apertures 40 and 42 at specified locations about the outer periphery of the shell and structural component to secure the assembly together.

Referring further to enlarged side cutaway of FIG. 3, the structural component 24 exhibits any number of deflectable and in-molded fastener clips, such as shown at 44, and which are formed at locations along an inner facing surface 46 of the component 24. The inner recessed surface 14 of the vehicle door includes a suitable number of proximately located apertures, see such as at 48.

Owing again to the tolerancing vagaries of the structural component, the deflectable clips 44 provide for a degree of misalignment relative to the apertures 48 and to permit the opposing three-dimensional surface configurations of the structural component and vehicle door to mate and the deflectable fasteners to engage the apertures and to secure the component (with affixed outer shell) in place.

It is further understood that the construction of the clips 44 are such that they are capable of moving in any given direction and within the tolerances required for accommodating the variances in the expanded polymer insert. Although not shown, a trough molded into the structural component could also capture a seal required for the water barrier. A similar trough could be molded to capture such as wire harnesses.

The process for producing the expanded foam structural insert 24 is understood to further allow for metal, nylon or other less heat sensitive parts to be inserted into the associated mold and thus into the finished part during the molding process. The shape of the molded insert also may include appropriate configurations for such as an arm rest or map pocket.

The required brackets, pass-through, fasteners and the like can also be molded into the structural component and it is also contemplated that additional components including water shields, additional side impact blocks, panel attachments, sound blockers and absorbers, wire harness brackets, speaker attachments, side air bag attachments, window motor attachments, and the like can be formed integrally with the expanded structural component 24. Consistent with the description provided above, the tolerancing vagaries of the structural component dictate that the mounting brackets used for speakers, door handles, locks, buttons, switches and such must be designed to fit into the shell with minimum variance.

As is also evident, the structural component 24 eliminates the need for separate molds, tools and process time for constructing such features as the map pockets, arm rests, side impact blocks, water deflectors and the like. It has been found that the costs associated with the elimination of such tools, molds, etc., is substantial. It has also been found that making the structural insert an integral part of the trim pad eliminates the need for access panels, as the door hardware and parts are easily accessible by simply removing the thermoformed shell.

Referring to FIG. 4, a cutaway illustration is shown at 50 of a further variant for securing a combination thermoformed shell 16′ and structural insert 24′ to an exposed facing surface 14′ forming a part of a vehicle door cavity. In particular, and as has been previously stated, it has been found that the tolerance issues involved with expanded polymer inserts 24 are more severe with sheet metal surfaces 14′ than with the interface between the surfaces associated with the structural insert 24′ and the thermoformed shell 16′. As such, it has been found that embedded fasteners, such as previously identified at 44 in FIG. 3, will not align with the sheet metal and unless engineering provisions were made.

One solution has been to further define an outer extending an annular lip edge 52, typically associated with the thermoformed shell 16′, and through which are engaged screw fasteners 54 (or other suitable engineering fasteners) for securing directly to corresponding locations along the sheet metal surface 14′ as illustrated. In this manner, the dimensional tolerancing vagaries associated with the expanded insert are obviated insofar as the requirement of fastener interconnections between the structural insert and the door surface. Additionally, and although not shown, the fastener interconnection between the shell 16′ and exposed door surface 14′ can occur at apertured locations of the assembled structural insert 24′ and owing to any particular thermoformed molding configuration of the shell 16′.

Having described my invention, additional preferred embodiments will become apparent to those skilled in the art to which it pertains and without deviating from the scope of the appended claims. In particular, it is also contemplated that the expanded plastic insert component 24 can operate independently of the outer thermoformed panel 16 and with or without any other type of fascia or decorative trim panel covering. In this variant, the dimensional misalignment tolerancing established between the structural component and the exposed vehicle door surface is increased, where necessary, to guarantee a secure fit and connection therebetween.

I claim:

1. A combination energy absorption and environmental insulating barrier incorporated into a vehicle door trim panel assembly, comprising:
a thermoformed shell having an exterior facing surface and an opposite recessed interior facing surface;
a three-dimensional structural component having a specified length, width and thickness and which is configured to substantially seat against said recessed interior facing surface of said shell; and
an exposed facing surface of said structural component securing against an inner associated surface of a vehicle door.

2. The trim panel assembly as described in claim 1, said thermoformed shell being constructed of an acetyl butyl styrene material.

3. The trim panel assembly as described in claim 1, further comprising a decorative covering applied against said exterior facing surface of said thermoformed shell.

4. The trim panel assembly as described in claim 3, said decorative covering comprising at least a vinyl or leather material.

5. The trim panel assembly as described in claim 1, said structural component being constructed of a durable plasticized and expanded foam material.

6. The trim panel assembly as described in claim 5, further comprising a dimensional misalignment tolerancing established between said opposing facing surfaces of said thermoformed shell and said expanded structural component.

7. The trim panel assembly as described in claim 6, further comprising interengaging portions established between said opposing surfaces of said shell and structural component and which facilitate inevitable misalignments due to tolerancing variances associated with said expanded foam component.

8. The trim panel assembly as described in claim 7, said interengaging portions further comprising at least one of Velcro® portions, spring clips or other types of adjustable fasteners.

9. The trim panel assembly as described in claim 7, further comprising at least one deflectable and in-molded fastener clip associated with said exposed facing surface of said expanded structural component and which engages through a proximately located aperture in the vehicle door.

10. The trim panel assembly as described in claim 9, said structural insert having a specified shape and size and exhibiting properties selected from the group including moisture imperviousness, acoustical insulation and impact resistance.

11. The trim panel assembly as described in claim 1, further comprising said structural component exhibiting a first three-dimensional exterior configured surface seating against said thermoformed shell, said exposed facing surface further comprising a second three-dimensional and exterior configured surface approximating that of the inner surface of the vehicle door.

12. The trim panel assembly as described in claim 10, further comprising said three-dimensional structural component being constructed of an energy absorbing structural foam.

13. The trim panel assembly as described in claim 12, further comprising said structural component being constructed of at least one of a urethane and an impact resistant styrene.

14. A combination energy absorption and environmental insulating barrier incorporated into a vehicle door trim panel assembly, comprising:
a thermoformed and hardened shell having an exterior facing surface and an opposite recessed interior facing surface;
a three-dimensional structural component constructed of a durable plasticized and expanded foam material and exhibiting the properties of moisture imperviousness and impact resistance, said structural component having a specified length, width and thickness and which is configured to substantially seat against said recessed interior facing surface of said shell, a dimensional misalignment tolerancing being established between said opposing facing surfaces of said thermoformed shell and said expanded structural component; and
an exposed facing surface of said structural component securing against an inner associated surface of a vehicle door.

15. A combination energy absorption and environmental insulating barrier incorporated into a vehicle door trim panel assembly, comprising:
a thermoformed and hardened shell having an exterior facing surface and an opposite recessed interior facing surface, a decorative covering being applied against an exposed facing surface of said shell;
a three-dimensional structural component constructed of a durable plasticized and expanded foam material and exhibiting the properties of moisture imperviousness, acoustical insulation and impact resistance, said structural component having a specified length, width and thickness and which is configured to substantially seat against said recessed interior facing surface of said shell, a dimensional misalignment tolerancing being established between said opposing facing surfaces of said thermoformed shell and said expanded structural component, interengaging portions being established between said opposing surfaces of said shell and said structural component and facilitating misalignment due to tolerancing variances associated with said expanded foam component; and
an exposed facing surface of said structural component including at least one deflectable and in-molded fastener clip for engaging through a proximately located aperture in a vehicle door to secure in place the trim panel assembly.

16. An energy absorbing and environmental insulating barrier incorporated into a vehicle door assembly, comprising:
a three-dimensional and expanded structural component having a specified length, width and thickness and which is configured to substantially seat within a recessed cavity associated with the vehicle door; and
a dimensional misalignment tolerancing established between opposing faces associated with the door and said expanded structural component.

17. A combination energy absorption and environmental insulating barrier incorporated into a vehicle door trim panel assembly, comprising:
a thermoformed shell having an exterior facing surface and an opposite recessed interior facing surface;
a three-dimensional structural component having a specified length, width and thickness and which is configured to substantially seat against said recessed interior facing surface of said shell; and
a location of at least said thermoformed shell securing against an exposed surface of a vehicle door.

18. The trim panel assembly as described in claim 17, said thermoformed shell further comprising at least one extending lip portion, in surface contact with the vehicle door surface, and through which is engaged a fastener.
